(19) United States
(12) Patent Application Publication
(10) Pub. No.: US 2004/0185995 A1
(43) Pub. Date: Sep. 23, 2004

(54) Method of folding a sheet into a folded sheet with a minimum of 16 sides

(75) Inventors: Joachim Hoffmann, Steinhime (DE); Bodo Tegtmeier, Alfdorf-Phahlbronn (DE); Eberhard Krieger, Weinstadt-Struempfelbach (DE)

Correspondence Address: ROTHWELL, FIGG, ERNST & MANBECK, P.C., 1425 K STREET, N.W., SUITE 800, WASHINGTON, DC, 20005, US

(73) Assignee: Maschinenbau Oppenweiler Binder GmbH & Co. KG, Oppenweiler (DE)

(21) Appl. No.: 10/801,833

(22) Filed: Mar. 17, 2004

(30) Foreign Application Priority Data
Mar. 18, 2003 (EP) 03 006 152.7

(51) Int. Cl. B31F 5/02

(52) U.S. Cl. 493/356

(57) ABSTRACT

In the process for folding a sheet into a folded sheet with a minimum of 16 pages (sides), a first folded sheet (12) with four pages is formed by virtue of the sheet (11) being folded around a folding line (21) running transversely to the feeding transporting direction (30). Continuing in the feeding transporting direction, the second and third folded sheets are formed by virtue of being folded around corresponding lines running along the feeding transporting direction. The third folded sheet (14) can then be deflected through 90° and, thereafter, folded, around its center line (22a, 22b) running longitudinally in relation to the continued-transporting direction (31), into a fourth folded sheet with 32 pages. This process makes it possible to achieve very high sheet-processing speeds.

### FIELD OF THE INVENTION

The invention relates to a process for folding a sheet into a folded sheet with at least 16 sides.

### DESCRIPTION OF THE BACKGROUND ART

DE 33 12 931 C2 has already disclosed a process for producing 16-page brochures from a sheet which is guided through successively arranged aligning and conveying tables and folders, which have folding rollers, buckle plates and glue nozzles and on which the sheet is folded along folding lines, glue being applied to at least some of the folding lines prior to the folding operation, and the folded sheet being trimmed at the edges.

In the case of the known processes, the sheet-folding operations take place in buckle folders which are arranged one after the other and at right angles to one another in each case. In one arrangement, two buckle folders may be arranged one behind the other with the same transporting direction, these being followed by a third folder arranged at right angles to the first two.

In addition to buckle folders, knife folders or zigzag folders and plow folders are also used for folding sheets.

Arranging the various folders to form folding installations renders the frequent right-angled deflection of the folded sheets necessary, as a result of which the sheet-processing speeds of the installation are adversely affected. In order to increase the sheet speeds, the practice of dividing up the stream of folded sheets into two streams of sheets which are to be folded further has been adopted, this resulting in the installation being very complex in terms of equipment.

### SUMMARY OF THE INVENTION

The object of the invention is to provide a process by means of which a folded sheet with at least 16 pages (sides) can be formed straightforwardly at a high sheet-processing speed.

This object is achieved by a process for folding a sheet into a folded sheet with at least 16 pages which comprises the following steps carried out directly one after the other:

a) said sheet is folded around a center line thereof running transversely to a feeding transporting direction of said sheet, whereby a first folded sheet with four pages is formed,

b) said first folded sheet is folded around a folding line running longitudinally in relation to said feeding transporting direction, whereby a second folded sheet with eight pages is formed,

c) said second folded sheet is folded around a folding line running longitudinally in relation to said feeding transporting direction, whereby a third folded sheet with sixteen pages is formed.

The process according to the invention allows very high sheet speeds since, up until the third folded sheet is formed, no deflection from the feeding transporting direction takes place. The third folded sheet, in comparison with the starting sheet, is relatively small and stable, with the result that it can be deflected at a very high installation speed, at which a fourth folded sheet can then also be formed.

The third folded sheet is advantageously pressed in the feeding transporting direction prior to being deflected, as a result of which the operations of deflecting it at the installation speed and of aligning it and transporting it further to form the fourth folded sheet can be carried out precisely.

The folding operations are thus facilitated if perforations are already formed, from the outset, in the sheets along the folding lines extending in the feeding transporting direction.

When the process according to the invention is carried out, a buckle folder is used for the first folding operation, a plow folder is used for the second and third folding operations, a deflecting table is used for the deflecting operation, and a knife folder is used for the fourth folding operation.

The two plow folders here are advantageously combined on one and the same structural element. A small press is preferably arranged between the plow folder and the deflecting table in order for the third folded sheet to be moved in a pressed-flat state, and with precise positioning, onto the deflecting table, with the result that a trimming operation can also take place there.

The cycle time can be reduced if the longitudinal side of the sheet runs transversely to the feeding transporting direction, i.e. the sheet is first folded around its longitudinally running center line.

### BRIEF DESCRIPTION OF THE DRAWINGS

An exemplary embodiment of the invention will be explained in more detail with reference to drawings, in which:

FIG. 1 shows a plan view of the sheet-folding sequence,

FIG. 2 shows a perspective view of the sheet-folding sequence from FIG. 1, and

FIG. 3 shows, schematically, a plan view of an installation used for the sheet folding.

### DETAILED DESCRIPTION OF THE INVENTION

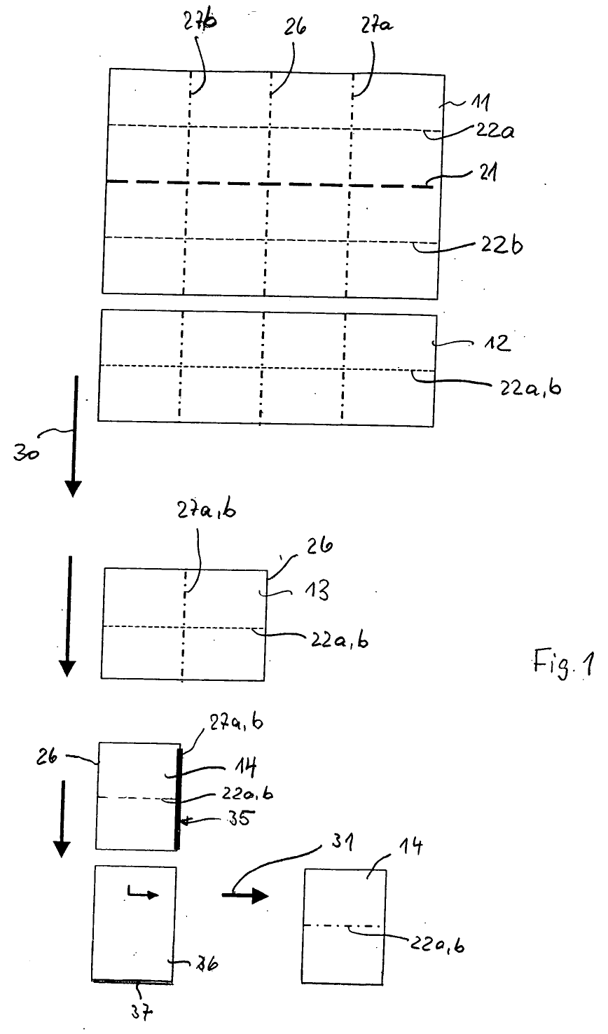

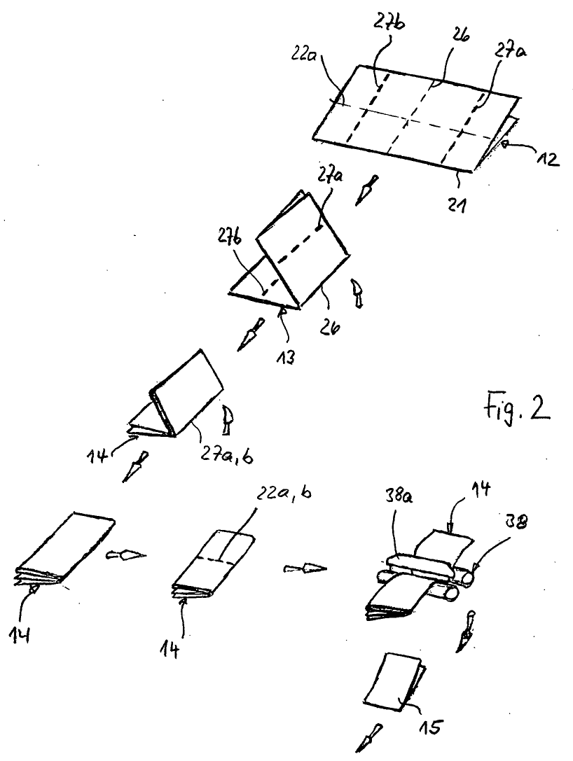

As is shown in FIGS. 1 and 2, the sheet 11 used has a center line 21 which runs transversely in relation to the transporting direction 30 of the sheet and parallel to the longitudinal side of the sheet 11, this resulting in the formation of two transverse zones, of which each, in turn, has a transverse center line 22a and 22b. The sheet 11 has a center line 26 in the transporting direction 30, this resulting in the formation of two lateral zones, of which each, in turn, has a longitudinal center line 27a and 27b. The longitudinal center lines 26, 27a and 27b are expediently perforated.

In a first folding step, the sheet 11 is folded around its center line 21 running transversely to its feeding transporting direction 30, as a result of which a first folded sheet 12 with four pages is formed. The first folded sheet 12 is then folded around its center line 26 running longitudinally in relation to the feeding transporting direction 30, as a result of which a second folded sheet 13 with eight pages is formed.

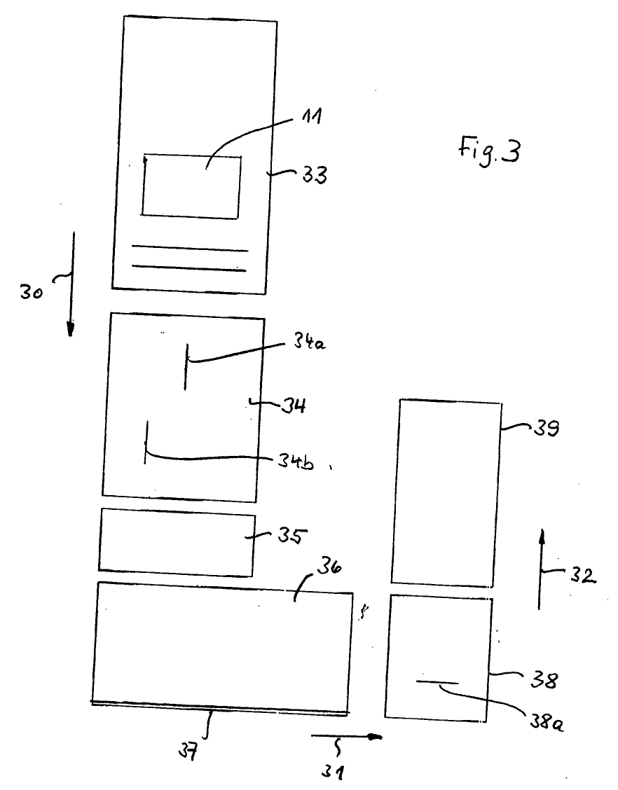

Thereafter, the second folded sheet 13 is folded around its center line 27a, 27b running longitudinally in relation to the feeding transporting direction 30, as a result of which a third folded sheet 14 with sixteen pages is formed. These folding operations can be carried out at very high sheet-transporting speeds, the third folded sheet 14 being relatively small in relation to the starting sheet and very stable as a result of the folding operations, with the result that it is possible for it to be deflected at right angles in a continued-transporting direction at the high sheet-transporting speed and folded around its center line running longitudinally in relation to the continued-transporting direction, as a result of which a fourth folded sheet with 32 pages is formed, all this being done at the constant sheet-transporting speed. The position of the folded sheet 15 is shown in FIGS. 2 and 3 rather than in FIG. 1. The folding lines which are located one upon the other can be gathered from FIGS. 1 and 2 in each case by the letters a and b being assigned to them.

As can be seen in part from FIGS. 1 and 2 and schematically from FIG. 3, the first folded sheet 12 is folded from the starting sheet 11 in a buckle folder 33, into which the starting sheet 11 runs transversely, i.e. with its longitudinal side in front. The buckle folder 33 discharges the sheet, in the feeding transporting direction 30, to a combined structural element 34, in which two plow folders 34a, 34b are provided one behind the other, in accordance with the respective arrangements, in the feeding transporting direction 30, the second folded sheet 13 and the third folded sheet 14 being formed by these plow folders. The third folded sheet 14 then passes through a small press 35, this resulting in the formation of a flat and stable third folded sheet, which is then transported onto the deflecting and cutting table 36, on which it is transported further along a guide bar 37 with precise alignment, in the continued-transporting direction 31, which is perpendicular to the feeding transporting direction 30. The trimmed third folded sheet 14 is then transported, in the continued-transporting direction, to a knife folder 38, on which is formed the fourth folded sheet with 32 pages, this folded sheet then being passed on in a known manner to a delivery means 39 with a transporting direction 32, which is parallel, but counter, to the feeding transporting direction 30.

The process according to the invention makes it possible, in comparison with the conventional processes, to double the sheet-transporting speeds since, up to the third folded sheet, the sheet-transporting direction remains unchanged. Since the sheet runs transversely into the buckle folder, the period of time which elapses between two successive sheets can be shortened.

In the case of the process described, the first folded sheet 12 is folded around the center line 26 and then around the center line 27a, 27b in order to form the third folded sheet 14. It is also possible, however, to fold first of all around the line 27a and then upward or downward around a further line 26 or 27b running in the feeding transporting direction 30. It is also possible to fold first of all around the line 27b and then upward or downward around a further line 26 or 27a running in the feeding transporting direction.

1. A process for folding a sheet into a folded sheet with at least 16 pages, wherein the following steps are carried out directly one after the other:
a) said sheet is folded around a center line thereof running transversely to a feeding transporting direction of said sheet, whereby a first folded sheet with four pages is formed,
b) said first folded sheet is folded around a folding line running longitudinally in relation to said feeding transporting direction, whereby a second folded sheet with eight pages is formed,
c) said second folded sheet is folded around a folding line running longitudinally in relation to said feeding transporting direction, whereby a third folded sheet with sixteen pages is formed.

2. The process as claimed in claim 1, wherein
d) said third folded sheet is deflected in a continued-transporting direction, which runs essentially at right angles to said feeding transporting direction, and
e) said third folded sheet is folded around a center line thereof running longitudinally in relation to said continued-transporting direction, whereby a fourth folded sheet with 32 pages is formed.

3. The process as claimed in claim 1, wherein said third folded sheet is pressed in said feeding transporting direction before it is deflected in said continued-transporting direction.

4. The process as claimed in claim 1, wherein perforations are formed in said sheet along said folding lines extending in said feeding transporting direction.

5. The process as claimed in claims 2, wherein a buckle folder is used for said folding operation according to a), a plow folder is used in each case for said folding operations according to b) and c), a deflecting table is used for said deflecting operation according to d), and a knife folder is used for said folding operation according to e).

6. The process as claimed in claim 5, wherein a structural element is used which combines said two plow folders.

7. The process as claimed in claim 5, wherein a small press is arranged between said plow folder and said deflecting table, said third folded sheet passing through said press in said feeding transporting direction.

8. The process as claimed in claim 1, wherein said longitudinal side of said sheet runs transversely to said feeding transporting direction.
